(19) United States
(12) Patent Application Publication
(10) Pub. No.: US 2007/0096475 A1
(43) Pub. Date: May 3, 2007

(54) Arrangement for guiding the deadlocking of a latch bolt in a door lock

(75) Inventor: Juha Raatikainen, Joensuu (FI)

Correspondence Address: SMITH-HILL AND BEDELL, P.C., 16100 NW CORNELL ROAD, SUITE 220, BEAVERTON, OR, 97006, US

(73) Assignee: ABLOY OY, JOENSUU (FI)

(21) Appl. No.: 10/553,295

(22) PCT Filed: Apr. 27, 2004
(86) PCT No.: PCT/FI04/00255

§ 371 Date: Oct. 14, 2005

(30) Foreign Application Priority Data
May 14, 2003 (FI) 20030719

(51) Int. Cl. E05C 1/02

(52) U.S. Cl. 292/137

(57) ABSTRACT

An arrangement for guiding the deadlocking of a latch bolt in a door lock comprising a lock case, which is provided with a latch bolt urged by a spring to a position protruding from the lock case, which latch bolt has a body part and at least one outwardly tapering wedge-shaped headpiece pivotably supported by the body part so that the latch bolt may be pressed into the lock case from either side thereof in the direction of door opening or closing due to a force acting upon said at least one wedge-shaped headpiece, an auxiliary bolt urged by a spring to a position protruding from the lock case, and a guide element, which is on one hand arranged to accomplish the deadlocking of the latch bolt and on the other hand to be in cooperation with the auxiliary bolt so that the auxiliary bolt is arranged to prevent the moving of the guide element to its position providing the deadlocking of the latch bolt, while the latch bolt is in its protruding position. The arrangement includes members which are arranged to allow the moving of the guide element to a position providing the deadlocking of the latch bolt only in case both the auxiliary bolt and the latch bolt are first moved to their retracted positions.

The invention relates to an arrangement for guiding the deadlocking of a latch bolt in a door lock in accordance with the preamble of claim 1.

A door lock provided with a latch bolt and an auxiliary bolt of the type discussed herein is disclosed in the Finnish patent specification FI 83802 C. The deadlocking of the latch bolt in this kind of door locks is accomplished simply by pressing the auxiliary bolt into the lock case. Normally this takes place when the door is being pushed to a closed position, whereby also the auxiliary bolt, in addition to the latch bolt itself, is retracted into the lock case urged by the doorframe and the striker plate thereon. When the door is in the closed position the latch bolt extends out into the opening in the striker plate of the lock, but the striker plate prevents the protrusion of the auxiliary bolt until the deadlocking of the latch bolt is released and the door is opened again. The deadlocking may be released in a way known per se, for instance by a door handle on the inside of the door, by a key, or by electrical remote control.

When the door is open, both the latch bolt and the auxiliary bolt are in their protruding positions in the above-discussed lock. If the auxiliary bolt is then pressed into the lock case either by accident or in case of misbehaviour, it activates simultaneously the deadlocking of the latch bolt, whereby the door cannot be closed simply by pushing, but one of the above-mentioned ways to release the deadlocking needs to be applied. Depending on the situation this can be fairly difficult, especially if the door is a public door used in daytime and in addition, it is electrically remote-controlled, whereby the signal reporting the malfunction is not necessarily immediately transmitted further.

An object of the invention is to provide a novel arrangement, the construction of which is as uncomplicated and reliable as possible and by means of which the above-described malfunction can be eliminated efficiently.

The object of the present invention may be achieved in a way described in claim 1 and in the other claims. According to the invention the arrangement includes members which are arranged so as to allow the moving of a guide element to a position providing the deadlocking of the latch bolt only in case both the auxiliary bolt and the latch bolt are first moved to their retracted positions. Thus the pressing of the auxiliary bolt in is not alone enough for activating the deadlocking of the latch bolt, but it will take place only after the door has been pushed to its closed position and both the latch bolt and the auxiliary bolt are retracted into the lock case urged by the door frame.

In a preferred practical embodiment said members include a separate stop member supported movably by the auxiliary bolt, which stop member is arranged to act upon the guide element, for instance a protrusion in it, so that it prevents the moving of the guide element to its position providing the deadlocking of the latch bolt, when the auxiliary bolt is in its protruding position. Thus said stop member can with advantage be arranged to be moved to a position, where it allows the moving of the guide element to a position providing deadlocking of the latch bolt. In order to secure the operation of the stop member it is urged by spring to its said position allowing the moving of the guide element.

The auxiliary bolt is preferably provided with a guiding piece attached to the lock case, which guiding member defines the freedom of movement of the stop member and is arranged to guide the movements of the auxiliary bolt. The stop member preferably comprises a guiding edge, which is in cooperation with the guide element and is turnable relative to said guiding piece. The guiding piece comprises wedge-shaped guide surfaces for the stop member, whereby they preferably define the turning freedom of the stop member.

The protrusion of the guide element is with advantage provided with a recess, where the stop member is normally located so that it prevents said turning movement of the stop member, while the latch bolt and the auxiliary bolt are in their protruding positions. Thus no separate stoppers are required for guiding the operation of the stop member itself.

The latch bolt may be provided with a guide surface, which is arranged to move the guide element so as to release the stop member from the impact of said recess, when the latch bolt is being pressed into the lock case. In a preferred practical embodiment said guide surface may be connected to the deadlocking member of the latch bolt, which member the guide element is arranged to act upon in order to accomplish deadlocking of the latch bolt.

The invention may preferably be applied to a lock case, which has also a dead bolt, just as is disclosed in the above-mentioned patent specification FI 83802 C. In that case said guide element is preferably arranged to guide also the movements of the dead bolt.

In the following the invention is described by way of example with reference to the attached drawings, in which

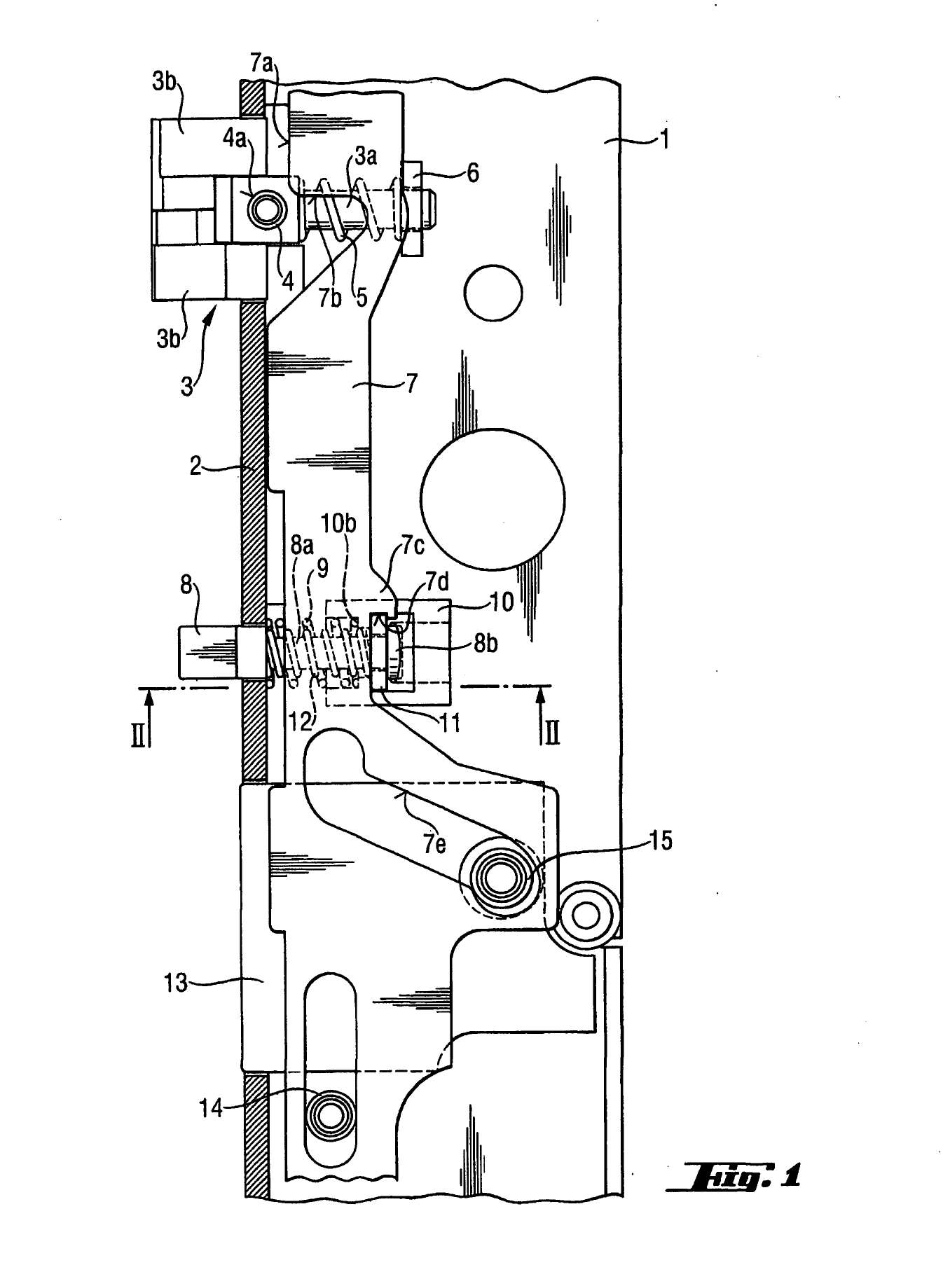

FIG. 1 is a side view of an arrangement according to the invention with an opened lock case in a situation where both the latch bolt and the auxiliary bolt are in their protruding positions;

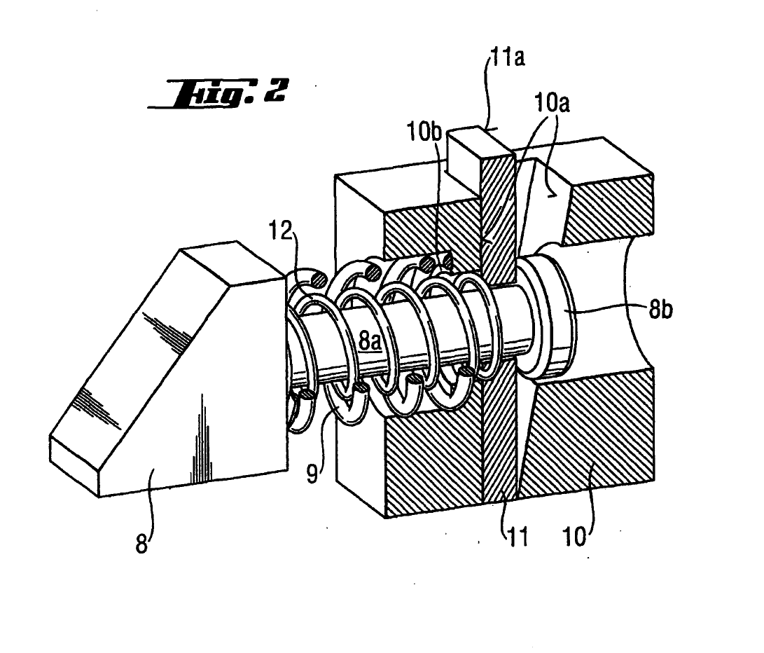

FIG. 2 shows a partial enlargement of FIG. 1, partly in section, and as perspective view taken on line II-II;

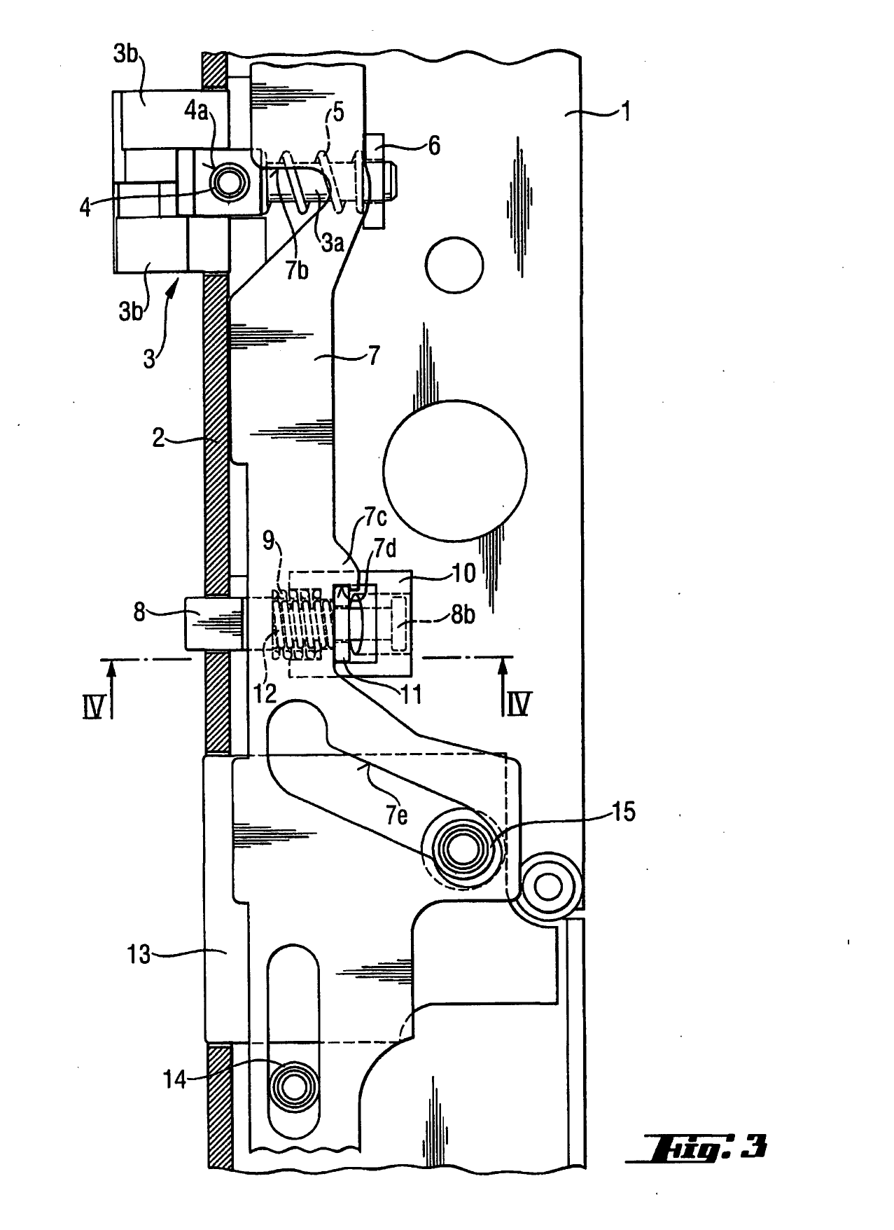

FIG. 3 shows the arrangement according to FIG. 1 in a situation where the auxiliary bolt is in a retracted position in the lock case;

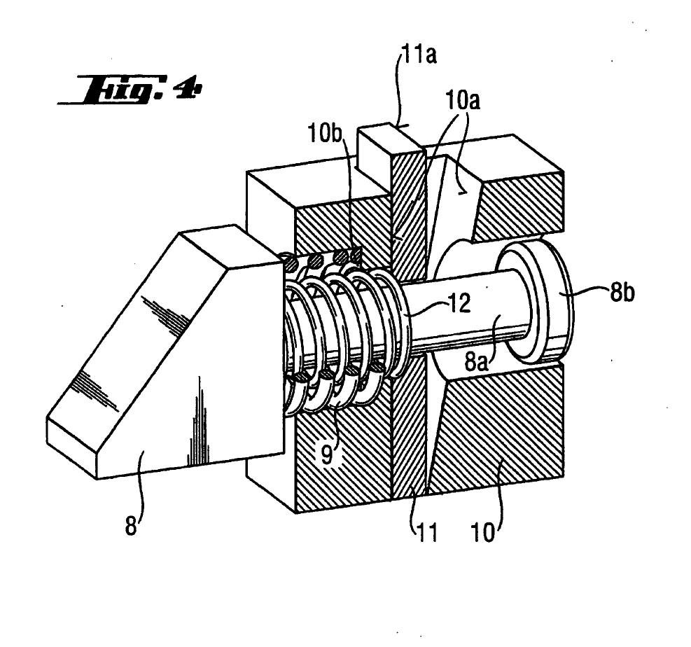

FIG. 4 shows a partial enlargement of FIG. 3, partly in section, and as perspective view taken on line IV-IV;

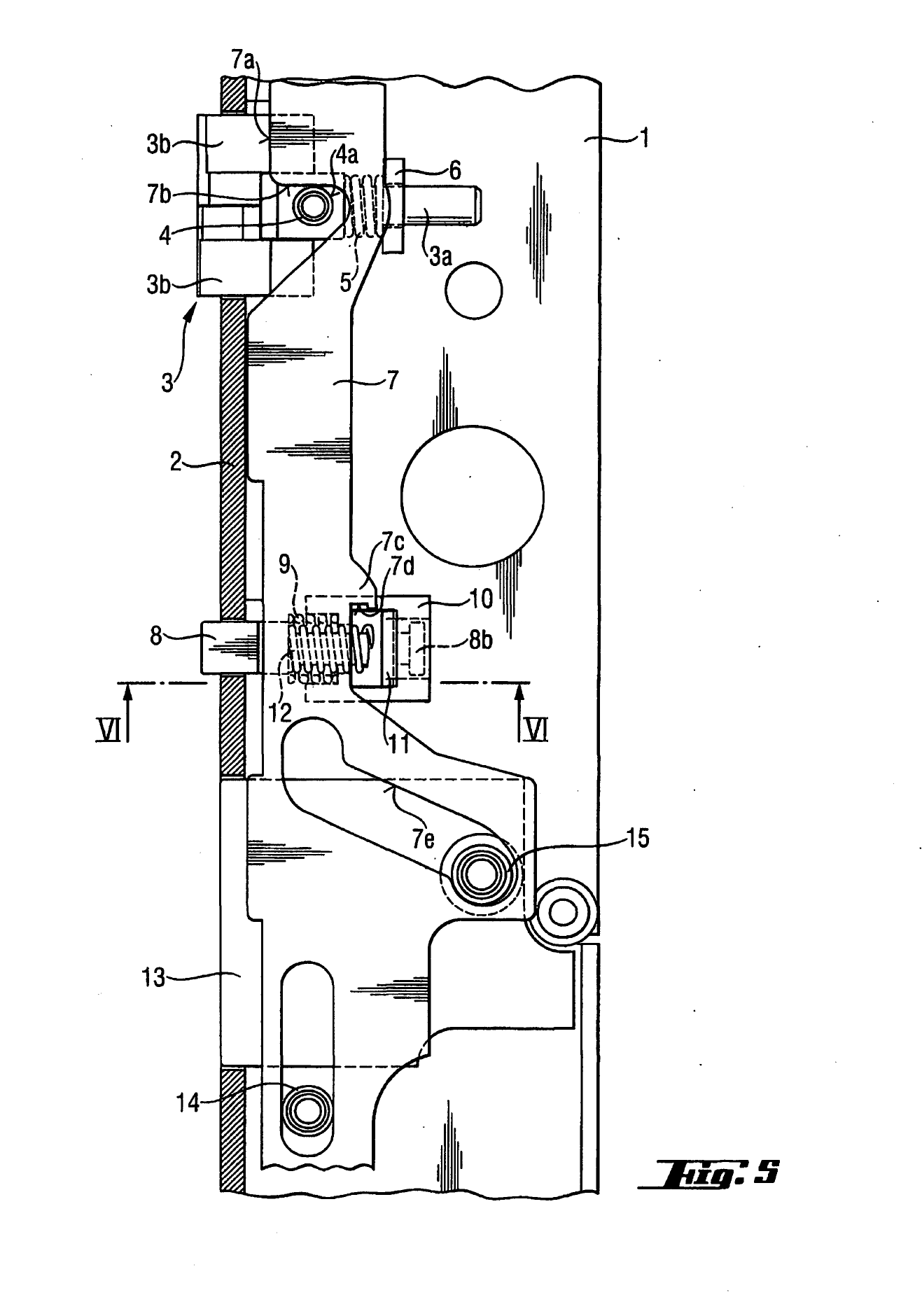

FIG. 5 shows the arrangement according to FIG. 1 in a situation where both the latch bolt and the auxiliary bolt are pressed into the lock case;

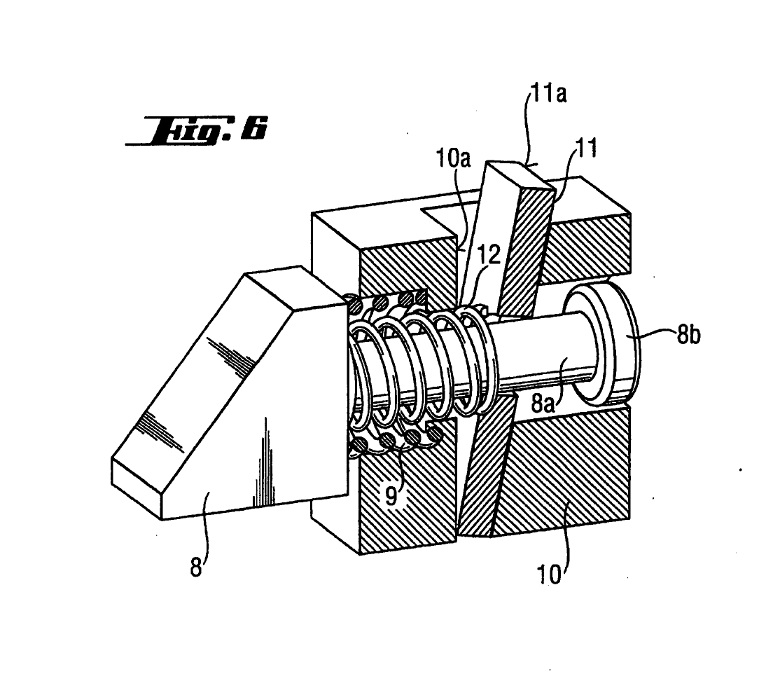

FIG. 6 shows a partial enlargement of FIG. 5, partly in section, and as perspective view taken on line VI-VI;

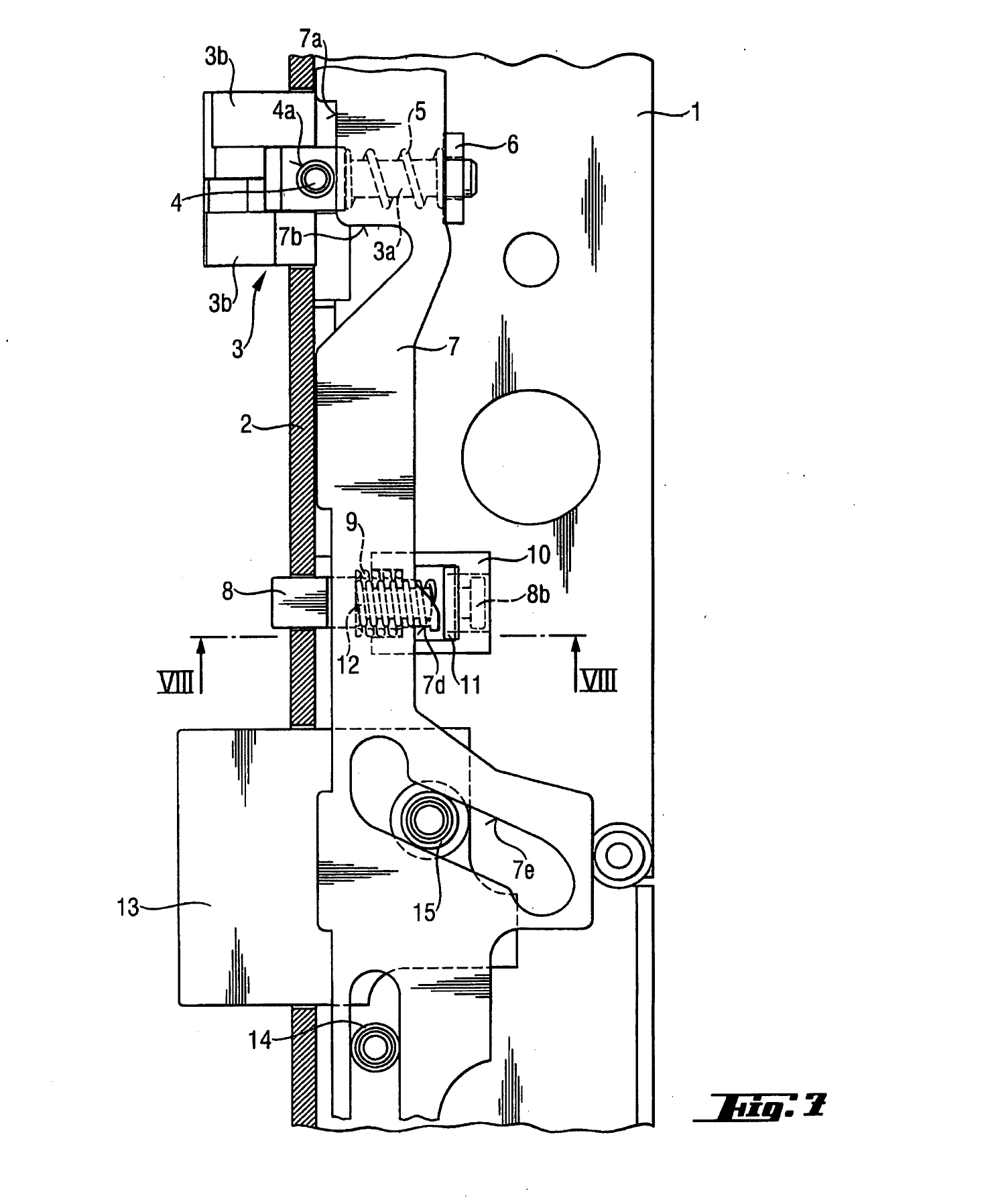

FIG. 7 shows the arrangement according to FIG. 1 corresponding the closed position of the door, where the latch bolt is in a protruding position and the auxiliary bolt is in a retracted position in the lock case;

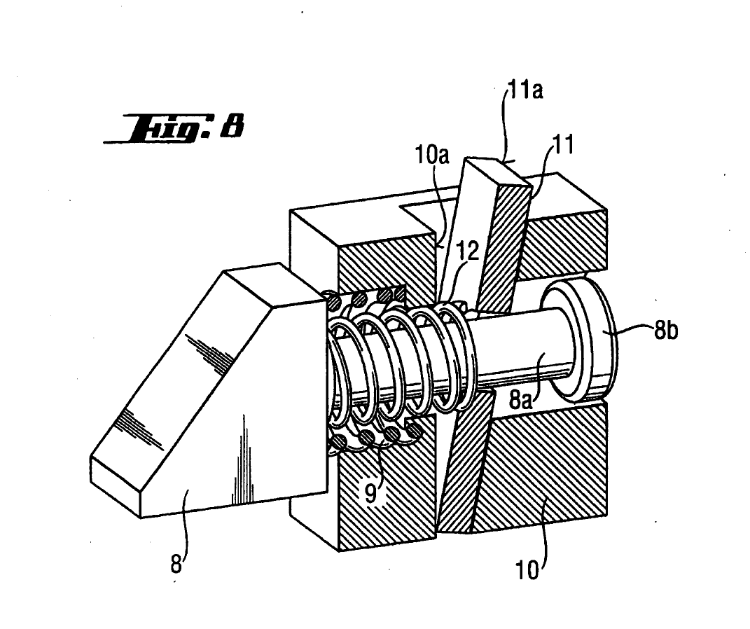

FIG. 8 shows a partial enlargement of FIG. 7, partly in section, and as perspective view taken on line VIII-VIII.

In the drawings the reference numeral 1 indicates a lock case to be installed in a door or the like, which lock case is provided with a front plate 2, and has a latch bolt 3 and an auxiliary bolt 8 as well as a guide element 7 operatively connected to these. In the embodiment according to the figures the lock case is further provided with a dead bolt 13, which is conventional as such, but the invention may be applied independently of the dead bolt.

The latch bolt 3 is of the type that it enables the opening and closing of the door without separate operational means so that the latch bolt is pressed to its retracted position in the lock case, when either wedge side of the tapering wedge-shaped end of the latch bolt protruding from the lock case hits the striker plate of the lock on the door frame. The latch bolt 3 according to the shown embodiment comprises a body part 3a, by which two separate wedgeshaped headpieces 3b are pivotably supported. This is similar to the construction shown in more detail in the patent specification FI 83802 C.

The latch bolt 3 is by means of a spring 5 urged to its position protruding from the lock case and the lock case is provided with a stopper 6 for the spring 5. The latch bolt 3 has also a deadlocking member 4, which is in cooperation with the guide surface 7a of a guide element 7 in order to accomplish deadlocking. The guide surface 4a of the deadlocking member 4 is in cooperation with a counter surface 7b of the guide element, as is described in more detail below.

The guide element 7 may be moved in the direction of the front plate 2 and the lock case is provided with relevant guiding members for guiding its movements, of which members a pin 14 is shown in FIGS. 1 and 7. The guide element 7 also comprises a protrusion 7c provided with a recess 7d, and a guide groove 7e, which is in cooperation with a pin 15 of the dead bolt 13 for guiding the movements of the dead bolt.

The auxiliary bolt 8 includes a body part 8a and a guide part 8b, which is in cooperation with a guiding piece 10 attached to the lock case. The auxiliary bolt 8 is by means of a spring 9 urged to, its protruding position and the spring 9 is also supported to a counter surface 10b in the guiding piece 10. In addition, the arrangement comprises a stop member 11, which is movably supported by the body part 8a of the auxiliary bolt and pressed by a spring 12 toward the lock case. The auxiliary bolt 8 may on one hand move relative to the stop member 11 and on the other hand the stop member is turnable relative to the body part 8a of the auxiliary bolt. Guide surfaces 10a of the guiding piece 10 define the turning freedom of the stop member 11.

The operation of the arrangement is as follows. In the situation according to FIGS. 1 and 2, where the latch bolt 3 and the auxiliary bolt 8 are out, which corresponds to the open position of the door, the stop member 11 is in the recess 7d of the guide element, whereby it prevents the guide element 7 from moving downwards in the figures to a position deadlocking the latch bolt 3. At the same time the recess 7d prevents the stop member 11 from turning away from this position in spite of the loading caused by the spring 12.

In the situation according to FIGS. 3 and 4 only the auxiliary bolt is pressed into the lock case. In this case both springs 9 and 12 yield, but the stop member 11 keeps the guide element 7 still in its upper, non-deadlocking position, whereby the door may still be pushed to its closed position without any operational means.

FIGS. 5 and 6 show a situation where both the latch bolt 3 and the auxiliary bolt 8 are pressed into the lock case 1, which relates to pushing the door to its closed position. Thus, at the same time as the latch bolt 3 moves inwards, the guide surface 4a included therein hits the counter surface 7b of the guide element and moves the guide element 7 somewhat upwards in the figures so that the stop member 11 is released from the impact of the recess 7d and turns, urged by the spring 12, to the position illustrated in FIGS. 5 and 6.

After this, when the door is completely closed, the latch bolt 3 is allowed to move into the bolt opening (not shown) in the striker plate of the lock in the doorframe, but the striker plate prevents the protrusion of the auxiliary bolt 8. This corresponds to the situation in FIGS. 7 and 8. At the same time as the latch bolt 3 is moved out, the stop face 7b of the guide element is released from the impact of the guide surface 4a of the latch bolt 3. Since the stop member 11 is still urged by the spring 12 to its turned position shown in FIGS. 5-8, the guide element 7 is allowed to move to its lower position shown in FIGS. 7 and 8, where it provides the deadlocking of the latch bolt 3 by means of its guide surface 7a. If the aim is to open the door, it requires moving of the guide element 7 again to its upper position according to FIGS. 1 and 2, which can be accomplished by several ways known per se, for instance by a door handle, by a key, or electrically. As it appears from the figures also the dead bolt 13 is then movable by means of the guide groove 7e in the guide element 7 to its retracted position enabling the opening of the door.

The invention is not limited to the above-described application, but several modifications are conceivable in the scope of the appended claims.

1-9. (canceled)

10. An arrangement for guiding the deadlocking of a latch bolt in a door lock comprising a lock case, which is provided with a latch bolt urged by a spring to a position protruding from the lock case, which latch bolt has a body part and at least one outwardly tapering wedge-shaped headpiece pivotably supported by the body part so that the latch bolt may be pressed into the lock case from either side thereof in the direction of door opening or closing due to a force acting upon said at least one wedge-shaped headpiece, an auxiliary bolt urged by a spring to a position protruding from the lock case, and a guide element, which is on one hand arranged to accomplish deadlocking of the latch bolt and on the other hand to be in cooperation with the auxiliary bolt so that the auxiliary bolt is arranged to prevent the moving of the guide element to its position providing the deadlocking of the latch bolt, while the latch bolt is in its protruding position, said arrangement including members which are arranged to allow the moving of the guide element to a position providing the deadlocking of the latch bolt only in case both the auxiliary bolt and the latch bolt are first moved to their retracted positions, characterised in that said members comprise a separate stop member movably supported by the auxiliary bolt, which stop member is arranged to act upon the guide element, for instance a protrusion in it, so that it prevents the moving of the guide element to a position providing the deadlocking of the latch bolt, while the auxiliary bolt is in its protruding position, and in that said stop member can be moved to a position, where it correspondingly allows the moving of the guide element to its position providing the deadlocking of the latch bolt.

11. An arrangement according to claim 10, characterised in that the stop member is urged by a spring to its position allowing the moving of the guide element.

12. An arrangement according to claim 10, characterised in that the auxiliary bolt is provided with a guiding piece attached to the lock case, which guiding piece defines the freedom of movement of the stop member and is arranged to guide the movements of the auxiliary bolt.

13. An arrangement according to claim 12, characterised in that the stop member comprises a guiding edge, which is in cooperation with the guide element and is turnable relative to said guiding piece.

14. An arrangement according to claim 13, characterised in that the guiding piece comprises wedge-shaped guide surfaces for the stop member.

15. An arrangement according to claim 10, characterised in that said protrusion of the guide element is provided with a recess, where the stop member is normally located so as to prevent said turning movement of the stop member, while the latch bolt and the auxiliary bolt are in their protruding positions.

16. An arrangement according to claim 15, characterised in that the latch bolt is provided with a guide surface, which is arranged to move the guide element so as to release the stop member from the impact of said recess, when the latch bolt is pressed into the lock case.

17. An arrangement according to claim 16, characterised in that said guide surface is connected to a deadlocking member of the latch bolt, which member the guide element is arranged to act upon in order to accomplish deadlocking of the latch bolt.

18. An arrangement according to claim 10 when applied to a lock case, which is also provided with a dead bolt, characterised in that said guide element is arranged to guide also the movements of the dead bolt.
